(19) United States
(12) Patent Application Publication
(10) Pub. No.: US 2026/0195592 A1
(43) Pub. Date: Jul. 9, 2026

(54) GENERATING METHOD FOR DEVICE-SPECIFIC ARTIFICIAL INTELLIGENCE MODEL AND APPARATUS USING DEVICE-SPECIFIC ARTIFICIAL INTELLIGENCE MODEL

(71) Applicant: Cubig Corp., Seoul (KR)

(72) Inventors: Min Chan CHUNG, Seoul (KR); Heon Seok HA, Seoul (KR)

(73) Assignee: Cubig Corp., Seoul (KR)

(21) Appl. No.: 19/442,680

(22) Filed: Jan. 7, 2026

(30) Foreign Application Priority Data
Jan. 9, 2025 (KR) 10-2025-0003223
Jan. 2, 2026 (KR) 10-2026-0000037

(51) Int. Cl. G06N 3/082

(52) U.S. Cl. CPC G06N 3/082

(57) ABSTRACT

A method for generating a device-specific artificial intelligence model includes obtaining, by a hardware device, unique information of a specific device, generating, by the hardware device, a neuron activation matrix based on the unique information, setting, by the hardware device, a degree of activation for neurons by applying the neuron activation matrix to neurons of a neural network model, and performing, by the hardware device, fine-tuning on the neurons for which the degree of activation has been set using a positive dataset.

### CROSS REFERENCE TO RELATED APPLICATIONS

This Application claims priority to Korean Patent Application Nos. 10-2025-0003223 (filed on January 9, 2025) and 10-2026-0000037 (filed on January 2, 2026), which are all hereby incorporated by reference in their entirety.

### BACKGROUND

The present disclosure relates to security techniques for on-device artificial intelligence (AI) services.

Recently, with advances in artificial intelligence technology, on-device AI is being commercialized. On-device AI enables real-time inference without network latency by using an AI model within a device. Additionally, on-device AI has advantages in terms of privacy protection since user data is not transmitted externally. However, on-device AI has a high risk of exposing the model itself, parameters, training data, inference results, and the like to attackers.

The description of the related art should not be assumed to be prior art merely because it is mentioned in or associated with this section. The description of the related art includes information that describes one or more aspects of the subject technology, and the description in this section does not limit the invention.

### SUMMARY

In one or more aspects of the present disclosure, there is provided a method for generating a device-specific artificial intelligence model. The method includes: obtaining, by a hardware device, unique information of a specific device; generating, by the hardware device, a neuron activation matrix based on the unique information; setting, by the hardware device, a degree of activation for neurons by applying the neuron activation matrix to neurons of a neural network model; and performing, by the hardware device, fine-tuning on the neurons for which the degree of activation has been set using a positive dataset.

In one or more aspects of the present disclosure, there is provided a method for inference using a device-specific artificial intelligence model. The method includes: extracting, by a device, its own unique information; generating, by the device, a neuron activation matrix based on the unique information; setting, by the device, a degree of activation for neurons by applying the neuron activation matrix to neurons of its own on-device neural network model; and performing, by the device, inference by inputting input data to the on-device neural network model including neurons for which the degree of activation has been set. The on-device neural network model is a model on which fine-tuning has been performed on the neurons for which the degree of activation has been set using a positive dataset during a training process.

In one or more aspects of the present disclosure, there is provided an apparatus for performing inference using a device-specific artificial intelligence model. The apparatus includes: an input device receiving input data; a storage device storing unique information and an on-device neural network model; and a processor configured to generate a neuron activation matrix based on the unique information, set a degree of activation for neurons by applying the neuron activation matrix to neurons of the on-device neural network model, and perform inference by inputting the input data to the on-device neural network model including neurons for which the degree of activation has been set. The on-device neural network model is a model on which fine-tuning has been performed on the neurons for which the degree of activation has been set using a positive dataset during a training process.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example of a system providing device-specific security.

FIG. 2 illustrates an example of a training process for on-device AI.

FIG. 3 illustrates another example of a training process for on-device AI.

FIGS. 4A-4B illustrate an example of differential activation within an AI model.

FIG. 5 illustrates an example of an inference process for on-device AI.

FIG. 6 illustrates another example of an inference process for on-device AI.

FIGS. 7A-7C illustrate an example of an attack on on-device AI having device-specific neuron activation.

FIG. 8 illustrates an example of a license management system for on-device AI.

FIG. 9 illustrates an example of a hardware device using on-device AI.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The following description relates to a device-dependent security technique for on-device AI.

Terms used in the following description will be explained.

On-device AI refers to AI that operates embedded in an independent device.

A device may be various types of apparatus. For example, a device may be any one of various devices such as a smartphone, PC, wearable device (smartwatch, headset, earphones, etc.), edge device (camera, robot, drone, etc.), vehicle, and the like.

Unique information is information that defines neurons to be activated in on-device AI. The unique information includes device-specific information, license keys, personal unique information, and the like.

Device-specific information is information that can uniquely identify a device. For example, device-specific information may include UUID (Universally Unique Identifier), IMEI (International Mobile Equipment Identity), MAC (Media Access Control) address, and the like.

A license key is unique information for on-device AI security services. A license key corresponds to information for identifying a specific on-device AI regardless of the device.

Personal unique information is information that uniquely identifies a user individual. Personal unique information may include identification information such as a social security number, biometric authentication information, and the like.

A neuron activation matrix is a matrix representing activation information for neurons of a specific AI model. The neuron activation matrix includes activation information for all neurons included in the neural network. At this time, the activation information may have a binary value of active (1) or inactive (0) for one neuron (hard activation). Alternatively, the activation information may be a value indicating the degree of activation of a neuron. The activation information may have a value within the range of [0,1] (soft activation).

Throughout this specification, references to activating, deactivating, or multiplying neurons are intended to encompass operations applied to data, parameters, or signals associated with the neurons, including weights, biases, activation outputs, or intermediate feature representations, rather than direct mathematical operations on the neurons as conceptual units.

Fine-tuning is a technique for optimizing performance by additionally training a pre-trained AI model for a specific task.

A positive dataset is a normal dataset for training an AI model to accurately perform a target task. For example, if the target task is object recognition in an image, the positive dataset is a dataset in which objects are accurately labeled.

A negative dataset is a dataset for inducing training so that an AI model incorrectly performs a target task. For example, if the target task is object recognition in an image, the negative dataset may be a dataset in which objects are intentionally mislabeled.

Hereinafter, it will be described that a hardware device constructs on-device AI. A hardware device is a computing device capable of signal processing, neural network operations, and the like. For example, a hardware device may be in the form of a PC, smart device, network server, data processing dedicated chipset, GPU-based processing device, and the like.

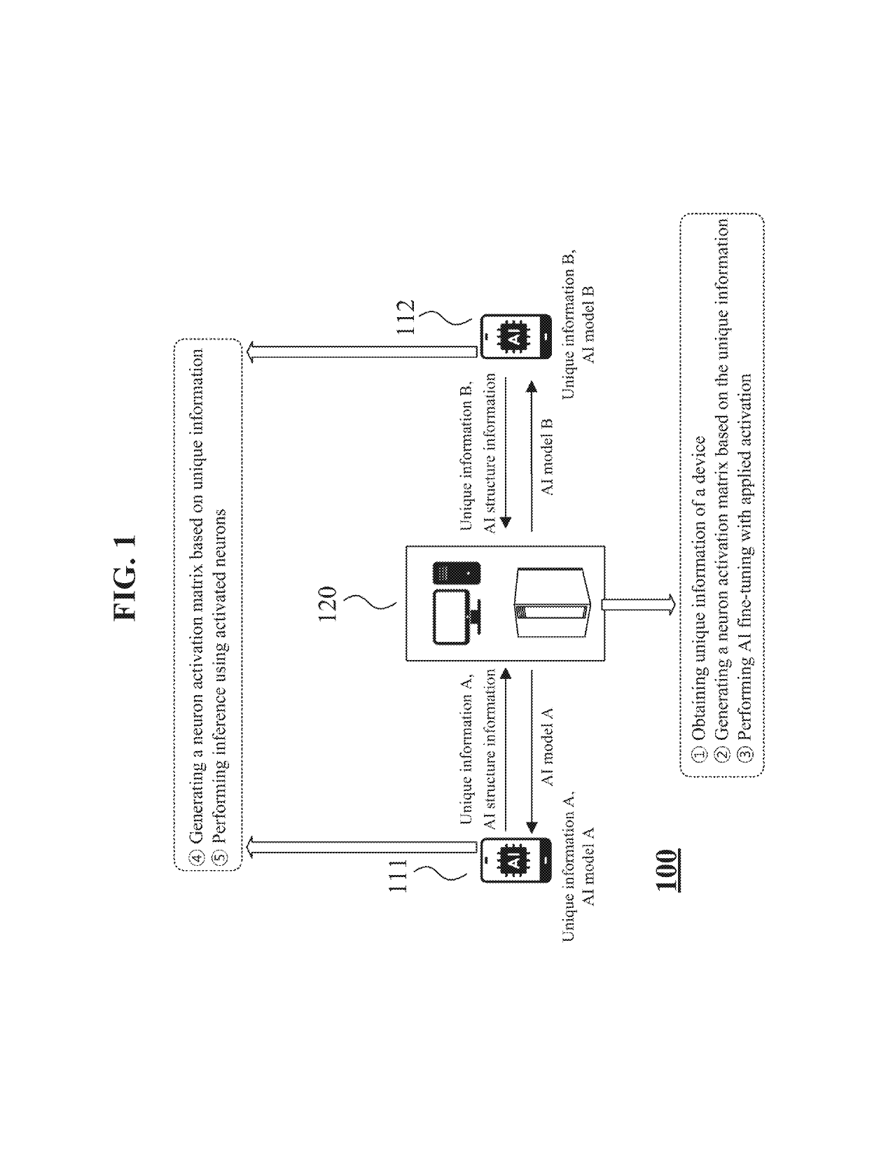

FIG. 1 illustrates an example of a system 100 providing device-specific security.

FIG. 1 illustrates a device 111 and a device 112 as examples. The device 111 and device 112 are apparatuses that provide inference using on-device AI.

In FIG. 1, the hardware device is illustrated with a PC and network server as examples.

The hardware device 120 obtains unique information A for the device 111 (①). The hardware device 120 may receive unique information A from the device 111. At this time, unique information A may include device-specific information or personal unique information.

Device-specific information is unique identification information such as UUID, IMEI, MAC address, product unique serial number, and the like. Personal unique information may include identification information such as a social security number, biometric authentication information, and the like.

The hardware device 120 may also generate unique information by combining various information extractable from the device. For example, the hardware device 120 may generate unique information by combining the IMEI and serial number of a smartphone. The hardware device 120 may generate unique information by combining the CPU ID, mainboard serial, SSD serial, and the like of a laptop. The hardware device 120 may generate unique information by combining the Vehicle Identification Number and ECU (Electronic Control Unit) serial of a vehicle.

The hardware device 120 may also receive AI structure information from the device 111. The AI structure information may include neuron positions or identifiers for each layer of the on-device AI.

The hardware device 120 may construct on-device AI using a pre-trained model. Therefore, the hardware device 120 may already possess AI structure information.

The hardware device 120 may generate a neuron activation matrix based on unique information A for the corresponding device (②). The neuron activation matrix includes activation information for all neurons included in the neural network. The hardware device 120 may determine neurons to be activated among all neurons based on unique information A. That is, the hardware device 120 may determine neurons to be activated according to unique information A with the number of activated neurons among all neurons as a condition. Alternatively, the hardware device 120 may determine neurons to be activated based on unique information A according to a preset activation ratio. That is, the hardware device 120 may determine the degree of activation of neurons so that the activation level of all neurons meets the condition according to unique information A with an activation level (e.g., 70%) as a condition.

The hardware device 120 may also generate a neuron activation matrix by applying different activation ratios according to layers or blocks of the model.

The hardware device 120 may element-wise multiply the neuron activation matrix with neurons of the initial AI model to set neurons to be activated in the corresponding model. The initial AI model may be an untrained model or a pre-trained model. The hardware device 120 may perform training on the initial AI model using a positive dataset (③). The hardware device 120 may perform fine-tuning using the positive dataset. At this time, the training target in the AI model is the activated neurons.

Alternatively, the hardware device 120 may element-wise multiply the neuron activation matrix with neurons of the initial AI model to set the degree of activation of each neuron. The initial AI model may be an untrained model or a pre-trained model. The hardware device 120 may perform training on the initial AI model using a positive dataset. The hardware device 120 may perform fine-tuning using the positive dataset. At this time, each neuron of the AI model is fine-tuned according to the degree of activation.

Through this process, the hardware device 120 constructs a trained AI model A. The hardware device 120 may transmit AI model A to the device 111.

Thereafter, the device 111 may perform inference using AI model A. The device 111 may generate a neuron activation matrix based on its own unique information (④). Therefore, the device 111 must possess an algorithm for generating the neuron activation matrix in advance. When the unique information is composed of a combination of multiple pieces of information, the device 111 must possess an algorithm for combining the unique information in advance. The device 111 may store the necessary algorithm together with AI model A.

The device 111 may element-wise multiply the neuron activation matrix with neurons of AI model A to set activation information and perform inference using the activated neurons (⑤).

Inference may be any one of various tasks. For example, inference may be various such as object classification, object recognition, object segmentation, image generation, image retrieval, text retrieval, speech recognition, language translation, and the like.

The device 112 is a device with different unique information from the device 111.

The hardware device 120 obtains unique information B for the device 112 (①). The hardware device 120 may receive unique information B from the device 112. At this time, unique information B may include device-specific information or personal unique information.

Device-specific information is unique identification information such as UUID, IMEI, MAC address, product unique serial number, and the like. Personal unique information may include identification information such as a social security number, biometric authentication information, and the like.

The hardware device 120 may also generate unique information by combining various information extractable from the device.

The hardware device 120 may also receive AI structure information from the device 112. The AI structure information may include neuron positions or identifiers for each layer of the on-device AI.

The hardware device 120 may construct on-device AI using a pre-trained model. Therefore, the hardware device 120 may already possess AI structure information.

The hardware device 120 may generate a neuron activation matrix based on unique information B for the corresponding device (②). The neuron activation matrix includes activation information for all neurons included in the neural network. The hardware device 120 may determine neurons to be activated among all neurons based on unique information B. That is, the hardware device 120 may determine neurons to be activated according to unique information B with the number of activated neurons among all neurons as a condition. Alternatively, the hardware device 120 may determine neurons to be activated based on unique information B according to a preset activation ratio. That is, the hardware device 120 may determine the degree of activation of neurons so that the activation level of all neurons meets the condition according to unique information B with an activation level (e.g., 70%) as a condition.

The hardware device 120 may also generate a neuron activation matrix by applying different activation ratios according to layers or blocks of the model.

The hardware device 120 may element-wise multiply the neuron activation matrix with neurons of the initial AI model to set neurons to be activated in the corresponding model. The initial AI model may be an untrained model or a pre-trained model. The hardware device 120 may perform training on the initial AI model using a positive dataset (③). The hardware device 120 may perform fine-tuning using the positive dataset. At this time, the training target in the AI model is the activated neurons.

Alternatively, the hardware device 120 may element-wise multiply the neuron activation matrix with neurons of the initial AI model to set the degree of activation of each neuron. The initial AI model may be an untrained model or a pre-trained model. The hardware device 120 may perform training on the initial AI model using a positive dataset. The hardware device 120 may perform fine-tuning using the positive dataset. At this time, each neuron of the AI model is fine-tuned according to the degree of activation.

Meanwhile, the hardware device 120 may also perform additional training on deactivated neurons using a negative dataset.

Through this process, the hardware device 120 constructs a trained AI model B. The hardware device 120 may transmit AI model B to the device 112.

Thereafter, the device 112 may perform inference using AI model B. The device 112 may generate a neuron activation matrix based on its own unique information (④). Therefore, the device 112 must possess an algorithm for generating the neuron activation matrix in advance. When the unique information is composed of a combination of multiple pieces of information, the device 112 must possess an algorithm for combining the unique information in advance. The device 112 may store the necessary algorithm together with AI model B.

The device 112 may element-wise multiply the neuron activation matrix with neurons of AI model B to set activation information and perform inference using the activated neurons (⑤).

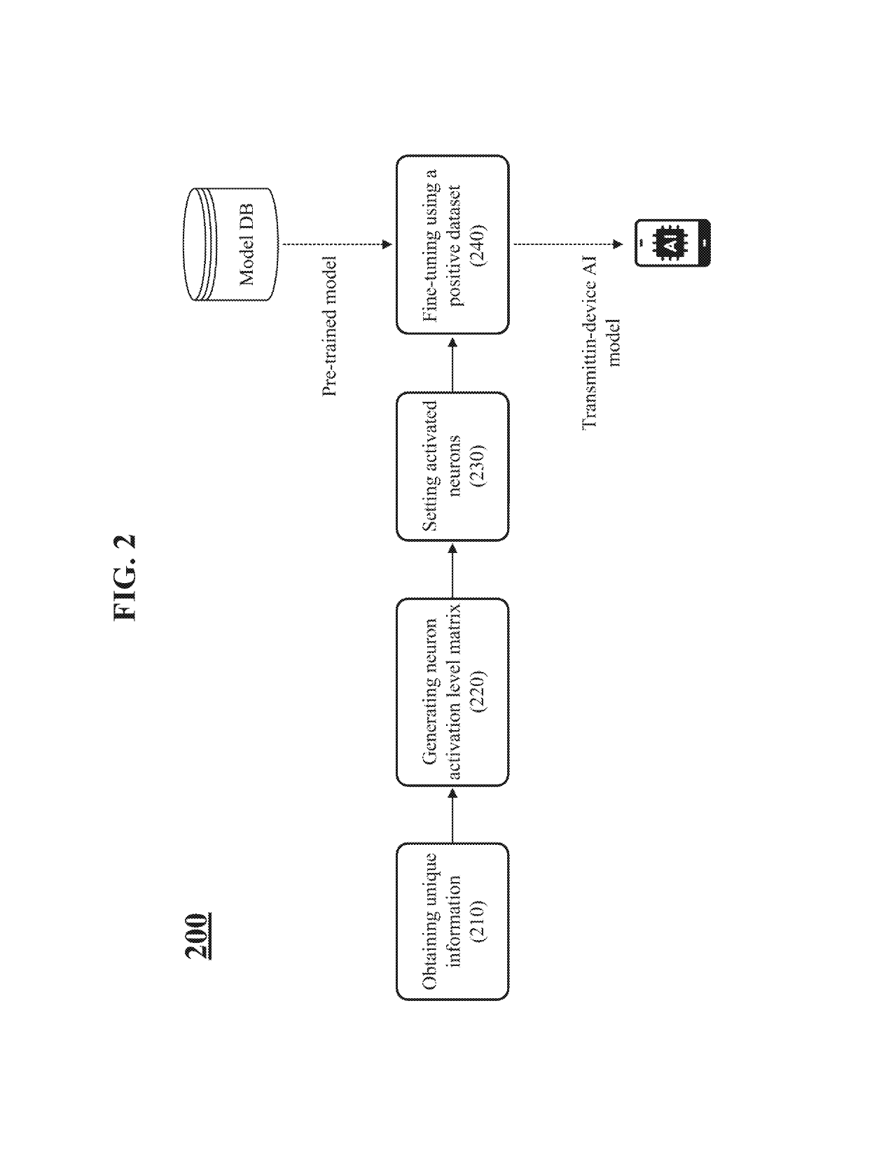

FIG. 2 illustrates an example of a training process 200 for on-device AI.

The hardware device obtains unique information of a target device (210).

The hardware device may extract device-specific information from the target device. Device-specific information is unique identification information such as UUID, IMEI, MAC address, product unique serial number, and the like.

The hardware device may extract personal unique information from the target device. Personal unique information may include identification information such as a social security number, biometric authentication information, and the like.

Meanwhile, the hardware device may also generate unique information by combining various information extractable from the device.

The hardware device generates a neuron activation matrix based on the unique information (220).

The hardware device may input the unique information into a hash function to generate a seed value. The hash function may be any one of various hash functions such as SHA-256, SHA-512, MD5, and the like. The hardware device may initialize a Pseudo-Random Number Generator (PRNG) using the generated seed value. The hardware device may deterministically generate neuron activation levels for each layer of the AI model using the initialized pseudo-random number generator.

The neuron activation matrix has the same form as the neural network structure of the AI model, and each element represents the degree of activation of the corresponding neuron. The neuron activation level may be expressed in hard activation mode or soft activation mode. In hard activation mode, each neuron has a binary value of 0 (deactivated) or 1 (activated). In soft activation mode, each neuron has a continuous real value between 0 and 1. In a hard activation mode, a neuron activation value of 0 effectively masks parameters or outputs associated with the corresponding neuron, such that the parameters or outputs associated with the neuron does not participate in forward or backward propagation. In contrast, in a soft activation mode, a neuron activation value between 0 and 1 scales parameters or outputs associated with the neuron, thereby adjusting a degree of contribution of the neuron to the neural network model.

The hardware device performs a deterministic operation of always generating the same neuron activation matrix from the same unique information.

The hardware device may receive a pre-trained model from a model DB (database). The hardware device may perform fine-tuning on the pre-trained model.

The hardware device sets neurons to be activated among the neurons of the original AI model using the generated neuron activation matrix (230). The hardware device may select activated neurons by element-wise multiplication of the neurons of the original AI model and the neuron activation matrix. As used herein, “element-wise multiplication of neurons” does not mean a mathematical operation applied to the neurons themselves as abstract entities. Rather, it refers to applying the neuron activation matrix to parameters, weights, activations, or outputs associated with the respective neurons of the neural network model. For example, an activation value corresponding to a neuron may be multiplied with a weight, bias, activation output, or intermediate feature value associated with that neuron, thereby controlling whether and to what degree the neuron contributes to inference or training. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The hardware device performs fine-tuning using a positive dataset targeting only the activated neurons (240). The positive dataset refers to training data suitable for the target inference task. For example, in the case of an image classification task, a dataset composed of correct images and labels of the corresponding category corresponds to a positive dataset. The hardware device excludes deactivated neurons from parameter updates during the training process. That is, the weights of deactivated neurons are not changed. The AI model is optimized to perform inference using only the activated neurons.

The hardware device may store the fine-tuned AI model in a storage device. The hardware device may transmit the fine-tuned AI model to the target device.

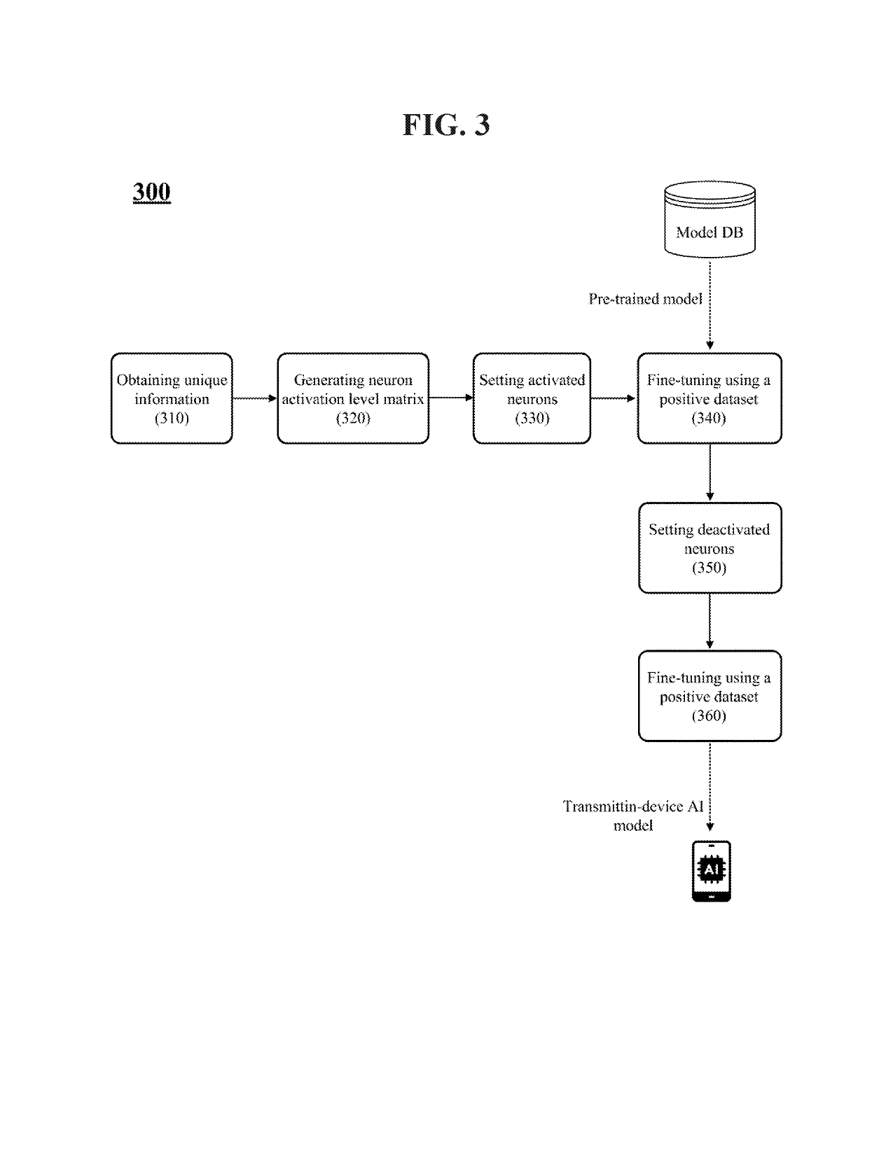

FIG. 3 illustrates another example of a training process 300 for on-device AI.

The hardware device obtains unique information of a target device (310).

The hardware device may extract device-specific information from the target device. Device-specific information is unique identification information such as UUID, IMEI, MAC address, product unique serial number, and the like.

The hardware device may extract personal unique information from the target device. Personal unique information may include identification information such as a social security number, biometric authentication information, and the like.

Meanwhile, the hardware device may also generate unique information by combining various information extractable from the device.

The hardware device generates a neuron activation matrix based on the unique information (320).

The hardware device may input the unique information into a hash function to generate a seed value. The hash function may be any one of various hash functions such as SHA-256, SHA-512, MD5, and the like. The hardware device may initialize a pseudo-random number generator (PRNG) using the generated seed value. The hardware device may deterministically generate neuron activation levels for each layer of the AI model using the initialized pseudo-random number generator.

The neuron activation matrix has the same form as the neural network structure of the AI model, and each element represents the degree of activation of the corresponding neuron. The neuron activation level may be expressed in hard activation mode or soft activation mode. In hard activation mode, each neuron has a binary value of 0 (deactivated) or 1 (activated). In soft activation mode, each neuron has a continuous real value between 0 and 1.

The hardware device performs a deterministic operation of always generating the same neuron activation matrix from the same unique information.

The hardware device may receive a pre-trained model from a model DB. The hardware device may perform fine-tuning on the pre-trained model.

The hardware device sets neurons to be activated among the neurons of the original AI model using the generated neuron activation matrix (330). The hardware device may select activated neurons by element-wise multiplication of the neurons of the original AI model and the neuron activation matrix. As used herein, “element-wise multiplication of neurons” does not mean a mathematical operation applied to the neurons themselves as abstract entities. Rather, it refers to applying the neuron activation matrix to parameters, weights, activations, or outputs associated with the respective neurons of the neural network model. For example, an activation value corresponding to a neuron may be multiplied with a weight, bias, activation output, or intermediate feature value associated with that neuron, thereby controlling whether and to what degree the neuron contributes to inference or training. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The hardware device performs fine-tuning using a positive dataset targeting only the activated neurons (340). The positive dataset refers to training data suitable for the target inference task. For example, in the case of an image classification task, a dataset composed of correct images and labels of the corresponding category corresponds to a positive dataset. The hardware device excludes deactivated neurons from parameter updates during the training process. That is, the weights of deactivated neurons are not changed. The AI model is optimized to perform inference using only the activated neurons.

The hardware device may set neurons to be deactivated among the neurons of the original AI model (350). The hardware device may generate a neuron deactivation matrix by inverting the neuron activation matrix. For example, the hardware device may generate a neuron deactivation matrix by subtracting each element of the neuron activation matrix from 1. For example, a neuron with an activation level of 1 is converted to 0, and a neuron with an activation level of 0 is converted to 1. In the case of soft activation mode, an activation level α is converted to (1-α).

The hardware device may set deactivated neurons by element-wise multiplication of the neurons of the original AI model and the neuron deactivation matrix.

The hardware device performs additional fine-tuning using a negative dataset targeting the deactivated neurons (360). The negative dataset refers to training data unrelated to the target task or that degrades performance.

The negative dataset may include at least one of the following. The negative dataset may include data of categories unrelated to the target task or data intentionally assigned wrong labels. Alternatively, the negative dataset may include data with added noise. For example, in the case of a model that classifies cats and dogs, the hardware device may train the deactivated neurons with unrelated images such as birds, cars, buildings, or train them with data that intentionally assigns a 'dog' label to cat images.

The hardware device trains the deactivated neurons to induce incorrect inference through negative fine-tuning. If an attacker steals and uses such a trained model, the inference performance of the model is significantly degraded.

The hardware device may store the fine-tuned AI model in a storage device. The hardware device may transmit the fine-tuned AI model to the target device.

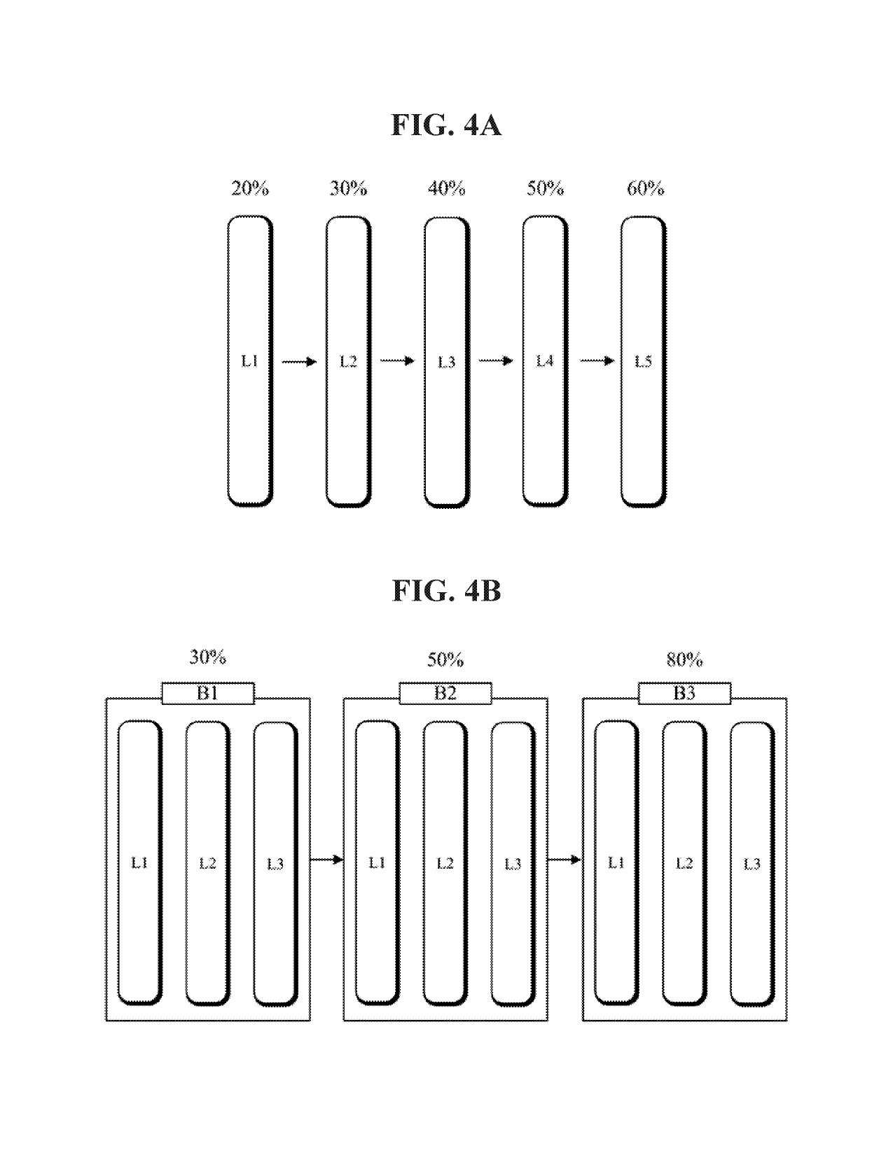

FIGS. 4A-4B illustrate an example of differential activation within an AI model. In an AI model, layers closer to the output layer have a greater influence on the final result. Therefore, stronger security may be applied to layers closer to the output layer, and relatively weaker security may be applied to layers closer to the input layer.

FIG. 4A is an example of applying different activation ratios to each layer of an AI model. In FIG. 4A, the AI model is composed of five layers (L1, L2, L3, L4, L5). Each layer is sequentially connected to process data. The activation ratio of each layer may be set to increase progressively (L1: 20% activation, L2: 30% activation, L3: 40% activation, L4: 50% activation, L5: 60% activation). The hardware device may generate a neuron activation matrix for each layer based on the activation ratio and unique information.

FIG. 4B is an example of setting different degrees of activation for each block of an AI model. One block may include multiple layers. In FIG. 4B, the AI model is composed of three blocks (B1, B2, B3). Each block internally includes three layers (L1, L2, L3). The activation ratio of each block is different: B1: 30% activation, B2: 50% activation, B3: 80% activation. The hardware device may generate a neuron activation matrix for each block based on the activation ratio and unique information.

The AI model may be a model based on various architectures. Depending on the model architecture, the layers to which the neuron activation matrix is applied may vary.

(1) A CNN (Convolutional Neural Network) includes convolutional filters and fully connected layers. The hardware device may apply activation levels to neurons of the convolutional filters and fully connected layers.

(2) A Transformer includes multi-head attention layers and feed-forward networks. The hardware device may apply activation levels to each head of the multi-head attention layer and neurons of the feed-forward network.

(3) An RNN (Recurrent Neural Network) or LSTM (Long Short-Term Memory) includes hidden layers. The hardware device may apply activation levels to each unit of the hidden state.

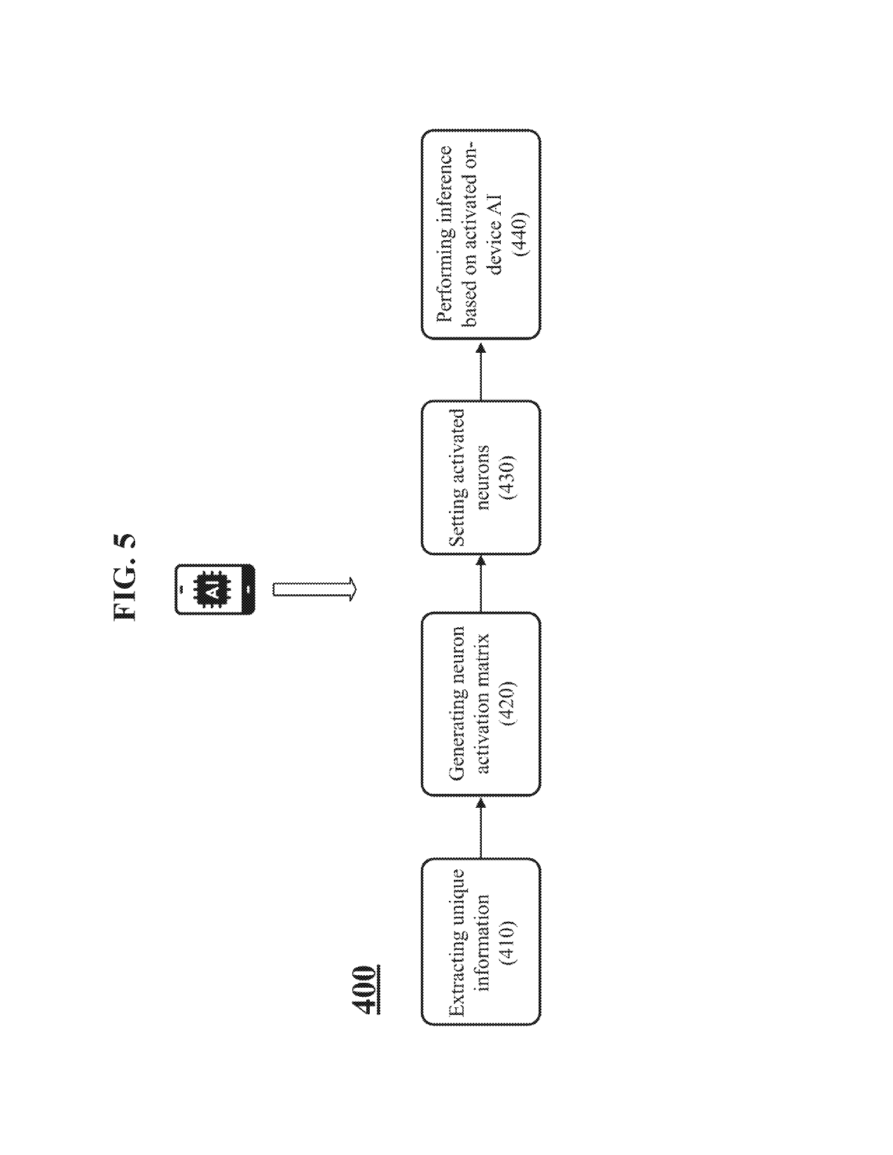

FIG. 5 illustrates an example of an inference process 400 for on-device AI. In FIG. 5, the device is an apparatus with embedded on-device AI. At this time, the on-device AI is a model constructed through the process of FIG. 2 or FIG. 3.

The device extracts unique information of the device (410). The unique information may be device-specific information or personal unique information. At this time, the unique information is the same as the information used by the hardware device in constructing the on-device AI. The device may read the unique information from a storage device or secure area.

The device generates a neuron activation matrix based on the extracted unique information (420). The neuron activation matrix defines the activation level for each neuron in the AI model. The device may input the unique information into a hash function to generate a seed value. The hash function may be any one of various hash functions such as SHA-256, SHA-512, MD5, and the like. The device may initialize a pseudo-random number generator (PRNG) using the generated seed value. The device may deterministically generate neuron activation levels for each layer of the AI model using the initialized pseudo-random number generator.

At this time, the same hash function and pseudo-random number generator as those used in the corresponding on-device AI construction process are used. Therefore, the hash function and pseudo-random number generator may be stored in the device together with the on-device AI.

The device sets neurons to be activated in the on-device AI model according to the generated neuron activation matrix (430). The device may select activated neurons by element-wise multiplication of the neurons of the on-device AI model and the neuron activation matrix. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The device may selectively activate specific neurons based on the activation level defined in the neuron activation matrix. The device performs on-device AI-based inference using only the neurons set to be activated (440). The device generates an inference result by inputting input data to the AI model composed of activated neurons.

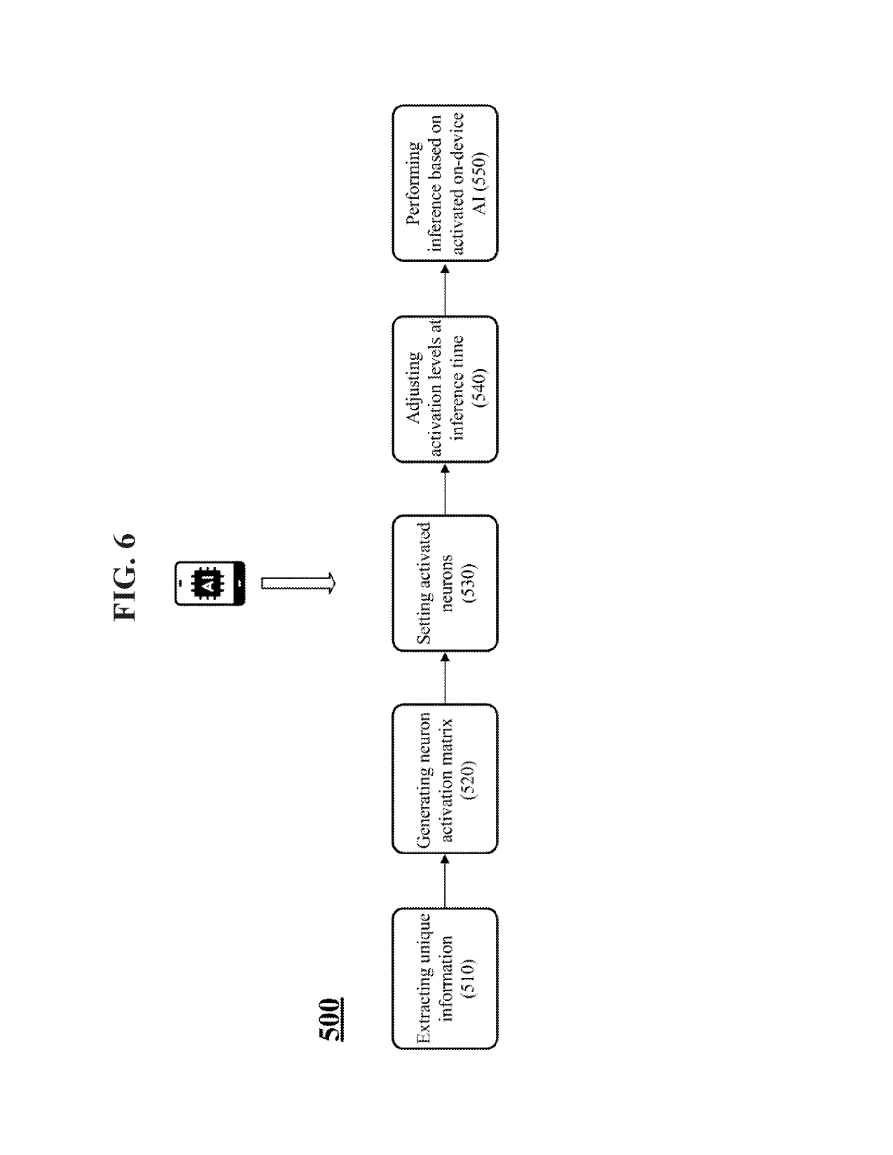

FIG. 6 illustrates another example of an inference process 500 for on-device AI. In FIG. 6, the device is an apparatus with embedded on-device AI. At this time, the on-device AI is a model constructed through the process of FIG. 2 or FIG. 3.

The device extracts its own unique information (510). The unique information may be device-specific information or personal unique information. At this time, the unique information is the same as the information used by the hardware device in constructing the on-device AI. The device may read the unique information from a storage device or secure area.

The device generates a neuron activation matrix based on the extracted unique information (520). The neuron activation matrix defines the activation level for each neuron in the AI model. The device may input the unique information into a hash function to generate a seed value. The hash function may be any one of various hash functions such as SHA-256, SHA-512, MD5, and the like. The device may initialize a pseudo-random number generator (PRNG) using the generated seed value. The device may deterministically generate neuron activation levels for each layer of the AI model using the initialized pseudo-random number generator.

At this time, the same hash function and pseudo-random number generator as those used in the corresponding on-device AI construction process are used. Therefore, the hash function and pseudo-random number generator may be stored in the device together with the on-device AI.

The device sets neurons to be activated in the on-device AI model according to the generated neuron activation matrix (530). The device may select activated neurons by element-wise multiplication of the neurons of the on-device AI model and the neuron activation matrix. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The device may dynamically adjust the activation level at the time of performing inference (540). The device may inject noise into the neuron activation matrix at every inference.

The device may use a timestamp or counter value at the inference time as an additional seed. For example, the device may initialize a pseudo-random number generator (PRNG) using a seed based on unique information and an additional seed in the random number generator. The device may generate a neuron activation matrix using the initialized pseudo-random number generator. That is, the device may adjust the neuron activation matrix at the inference time.

Alternatively, the device may add noise to the neuron activation matrix. The device may initialize a pseudo-random number generator (PRNG) with a timestamp or counter value at the inference time to generate noise. For example, the device may add noise in the range of ±0.05 to a neuron with a basic activation level of 0.8 to adjust it to a value between 0.75 and 0.85. Such a small change has almost no effect on inference performance due to the robustness of the model learned during the fine-tuning process.

The device may selectively activate specific neurons based on the activation level defined in the adjusted neuron activation matrix. The device performs on-device AI-based inference using only the neurons set to be activated (550). The device generates an inference result by inputting input data to the AI model composed of activated neurons.

When inference is performed in the manner of FIG. 6, even if an attacker captures the activation pattern by dumping memory at a specific time, it is difficult to identify the activation pattern because a different neuron combination is used in the next inference. Additionally, even if an attacker attempts to estimate the activation pattern through side-channel attacks such as power consumption or electromagnetic wave analysis, a consistent signature cannot be obtained because a different pattern is used each time.

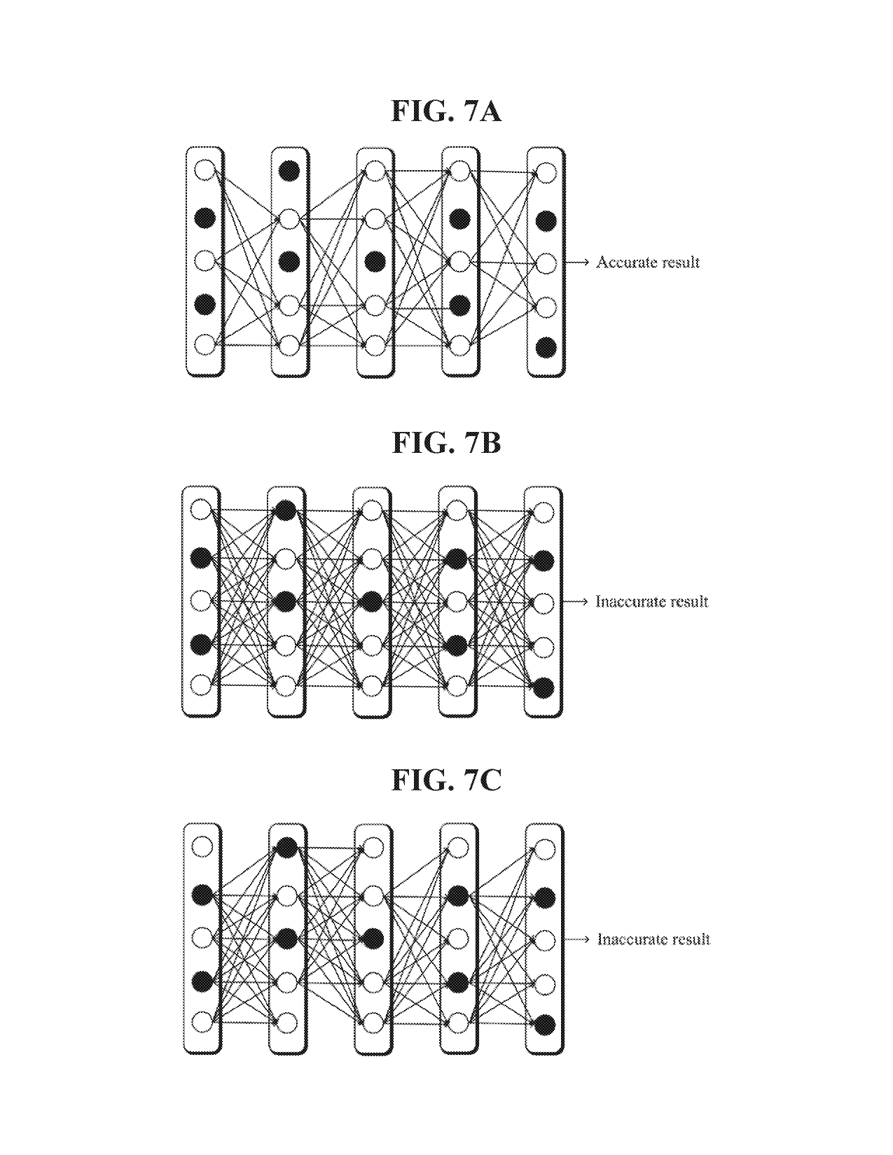

FIGS. 7A-7C illustrate an example of an attack on on-device AI having device-specific neuron activation. FIGS. 7A-7C represent a scenario in which an attacker steals an AI model from a legitimate device and then attempts to perform inference using the model. FIGS. 7A-7C are an example of hard activation mode.

In FIGS. 7A-7C, each vertical bar represents a layer of the neural network, and each circle represents a neuron. White circles represent activated neurons, and black circles represent deactivated neurons. Connection lines between layers represent weight connections between neurons.

FIG. 7A illustrates an example of a neural network partially activated using a neuron activation matrix. In FIG. 7A, white represents activated neurons and black represents deactivated neurons. FIG. 7A represents the inference process of on-device AI operating on a legitimate device. A legitimate device performs inference accurately using selectively activated neurons according to its unique information. A legitimate device obtains accurate result.

FIGS. 7B and 7C are examples of an attacker who stole the model of FIG. 7A performing inference using the model.

FIG. 7B illustrates an example of an attacker performing inference using all neurons. The attacker wants to execute the stolen model on their own device. Since the attacker does not know the neuron activation matrix, they attempt inference by activating all neurons. Since the attacker performs inference using neurons that were not activated during the training process, the attacker obtain inaccurate results or distorted inference results.

FIG. 7C illustrates an example of an attacker performing inference using randomly selected neurons among all neurons. The attacker attempts to activate only some of the neurons. Since the attacker does not know the legitimate neuron activation matrix, they select and activate neurons according to arbitrary criteria. In this case as well, the attacker uses some deactivated neurons in each layer. Therefore, the attacker obtains inaccurate results or distorted inference results.

The neuron activation matrix functions as a kind of cryptographic key. With recent hardware developments, the number of neurons in neural networks is greatly increasing. That is, the number of neuron combinations that an attacker must search greatly increases. Therefore, a Brute Force Attack is not effective. Furthermore, applying Soft activation (real numbers between 0 and 1) further increases security complexity.

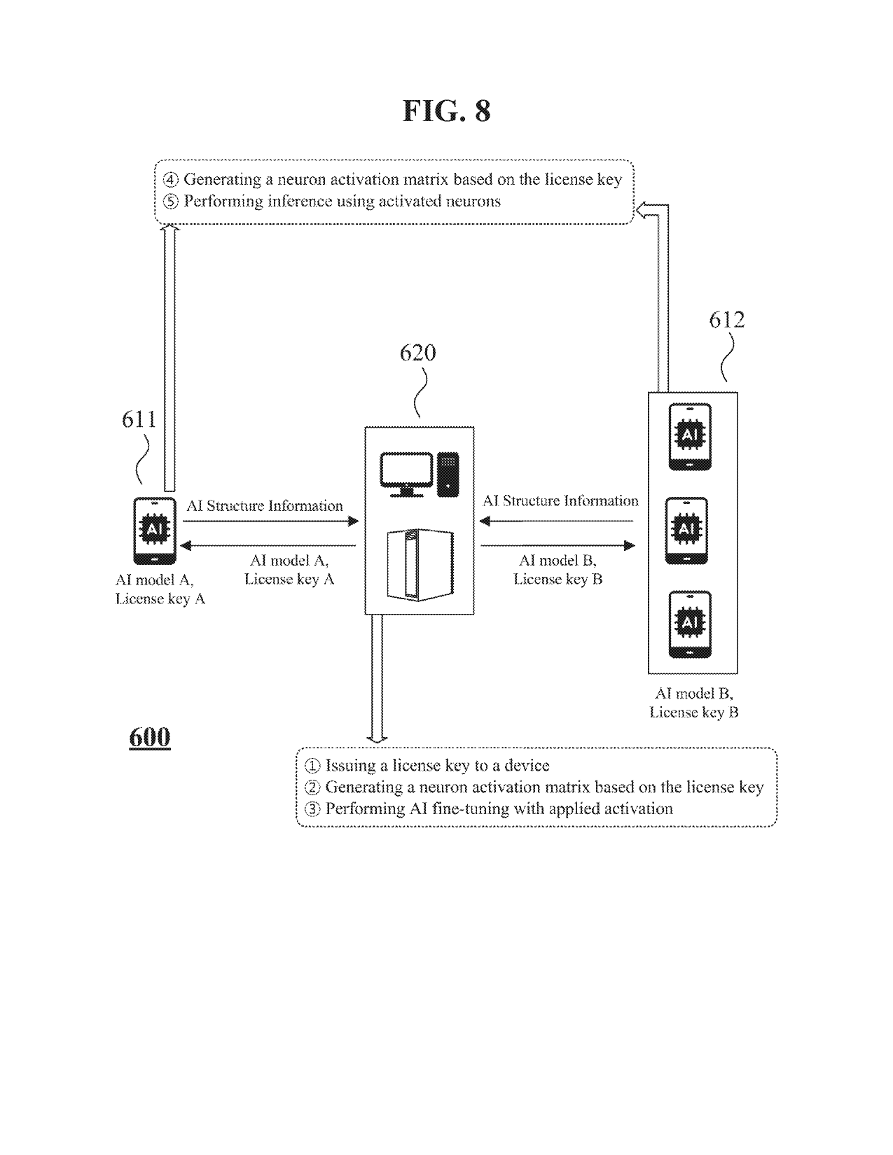

FIG. 8 illustrates an example of a license management system 600 for on-device AI. FIG. 8 is an on-device AI security provision system using a license key instead of unique information of a device. The system 600 provides security for on-device AI using a license key instead of hardware-specific information of a device. A license key is a value that the system 600 assigns to a specific device or device group.

FIG. 8 illustrates a device 611 and a device group 612 as examples. The device 111 is a single device that provides inference using on-device AI.

The device group 612 includes devices that perform inference using the same on-device AI. For example, the device group 612 may be devices used by coworkers performing the same task.

In FIG. 8, the hardware device is illustrated with a PC and network server as examples.

The hardware device 620 issues license key A for the device 611 (①). A license key is a unique identifier that grants usage rights for an AI model to the corresponding device or user.

The hardware device 620 may also receive AI structure information from the device 611. The AI structure information may include neuron positions or identifiers for each layer of the on-device AI.

The hardware device 620 generates a neuron activation matrix based on the issued license key A (②). The neuron activation matrix includes activation information for all neurons included in the neural network. The hardware device 620 may determine neurons to be activated among all neurons based on license key A. That is, the hardware device 620 may determine neurons to be activated according to license key A with the number of activated neurons among all neurons as a condition. Alternatively, the hardware device 620 may determine neurons to be activated based on license key A according to a preset activation ratio. That is, the hardware device 620 may determine the degree of activation of neurons so that the activation level of all neurons meets the condition according to license key A with an activation level (e.g., 50%) as a condition.

The hardware device 620 may also generate a neuron activation matrix by applying different activation ratios according to layers or blocks of the model.

The hardware device 620 may element-wise multiply the neuron activation matrix with neurons of the initial AI model to set neurons to be activated in the corresponding model. The initial AI model may be an untrained model or a pre-trained model. The hardware device 620 may perform training on the initial AI model using a positive dataset (③). The hardware device 620 may perform fine-tuning using the positive dataset. At this time, the training target in the AI model is the activated neurons.

Alternatively, the hardware device 620 may element-wise multiply the neuron activation matrix with neurons of the initial AI model to set the degree of activation of each neuron. The initial AI model may be an untrained model or a pre-trained model. The hardware device 620 may perform training on the initial AI model using a positive dataset. The hardware device 620 may perform fine-tuning using the positive dataset. At this time, each neuron of the AI model is fine-tuned according to the degree of activation.

Meanwhile, the hardware device 620 may also perform additional training on deactivated neurons using a negative dataset.

Through this process, the hardware device 620 constructs a trained AI model A. The hardware device 620 may transmit AI model A to the device 611.

Thereafter, the device 611 may perform inference using AI model A. The device 611 may generate a neuron activation matrix based on its own unique information (④). Therefore, the device 611 must possess an algorithm for generating the neuron activation matrix in advance. When the unique information is composed of a combination of multiple pieces of information, the device 611 must possess an algorithm for combining the unique information in advance. The device 611 may store the necessary algorithm together with AI model A.

The device 611 may element-wise multiplication the neuron activation matrix with AI model A to set activation information and perform inference using the activated neurons (⑤).

The hardware device 620 issues license key B for the device group 612 (①). A license key is a unique identifier that grants usage rights for an AI model to the corresponding device or user.

The hardware device 620 may also receive AI structure information from the device group 612. The AI structure information may include neuron positions or identifiers for each layer of the on-device AI.

The hardware device 620 generates a neuron activation matrix based on the issued license key B (②). The neuron activation matrix includes activation information for all neurons included in the neural network. The hardware device 620 may determine neurons to be activated among all neurons based on license key B. That is, the hardware device 620 may determine neurons to be activated according to license key B with the number of activated neurons among all neurons as a condition. Alternatively, the hardware device 620 may determine neurons to be activated based on license key B according to a preset activation ratio. That is, the hardware device 620 may determine the degree of activation of neurons so that the activation level of all neurons meets the condition according to license key B with an activation level (e.g., 50%) as a condition.

The hardware device 620 may also generate a neuron activation matrix by applying different activation ratios according to layers or blocks of the model.

The hardware device 620 may element-wise multiply the neuron activation matrix with neurons of the initial AI model to set neurons to be activated in the corresponding model. The initial AI model may be an untrained model or a pre-trained model. The hardware device 620 may perform training on the initial AI model using a positive dataset (③). The hardware device 620 may perform fine-tuning using the positive dataset. At this time, the training target in the AI model is the activated neurons.

Alternatively, the hardware device 620 may element-wise multiply the neuron activation matrix with neurons of the initial AI model to set the degree of activation of each neuron. The initial AI model may be an untrained model or a pre-trained model. The hardware device 620 may perform training on the initial AI model using a positive dataset. The hardware device 620 may perform fine-tuning using the positive dataset. At this time, each neuron of the AI model is fine-tuned according to the degree of activation.

Meanwhile, the hardware device 620 may also perform additional training on deactivated neurons using a negative dataset.

Through this process, the hardware device 620 constructs a trained AI model B. The hardware device 620 may transmit AI model B to the device group 612.

Thereafter, the device group 612 may perform inference using AI model B. The device group 612 may generate a neuron activation matrix based on its own unique information (④). Therefore, the device group 612 must possess an algorithm for generating the neuron activation matrix in advance. When the unique information is composed of a combination of multiple pieces of information, the device group 612 must possess an algorithm for combining the unique information in advance. The device group 612 may store the necessary algorithm together with AI model B.

A device belonging to the device group 612 may element-wise multiplication the neuron activation matrix with AI model B to set activation information and perform inference using the activated neurons (⑤).

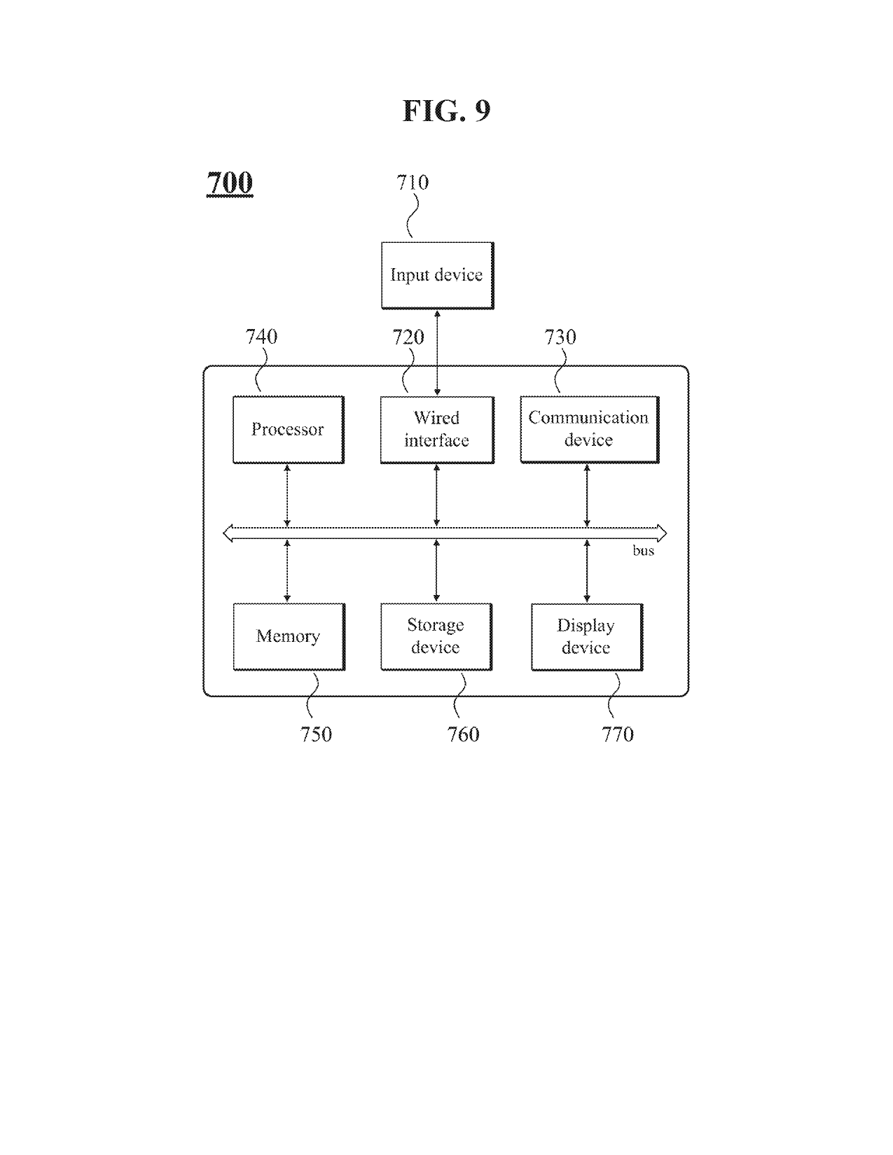

FIG. 9 illustrates an example of a hardware device 700 using on-device AI. The hardware device 700 is any one of various devices using on-device AI. The hardware device 700 may be any one of various types of devices such as a smartphone, wearable device, laptop, PC, robot, vehicle, and the like.

The hardware device 700 may include an input device 710, wired interface 720, communication device 730, processor 740, memory 750, and storage device 760.

Alternatively, the hardware device 700 may include an input device 710, wired interface 720, communication device 730, processor 740, memory 750, storage device 760, and display device 770.

Each internal component of the hardware device 700 may be connected by a bus. A specific bus may be used depending on the type of entity being connected. For example, the bus may be any one of AMBA (AHB/AXI/APB), PCIe, SPI (Serial Peripheral Interface), or MIPI (Mobile Industry Processor Interface).

The input device 710 is a device that receives user commands or information.

Additionally, the input device 710 may be a device that receives necessary data from an externally connected device or storage device.

The input device 710 may receive input data that is a target of inference.

The input device 710 may receive a constructed on-device AI. At this time, the on-device AI is a model trained through the process of FIGS. 2 to 3.

The input device 710 may be any one of various types of devices. For example, the input device 710 may be at least one of a mouse, keyboard, touch input device, camera, SCSI (Small Computer System Interface) device, PCI (Peripheral Component Interconnect) bus-based device, or ATAPI (ATA Packet Interface) device.

The wired interface 720 is a device component that transmits data delivered by the input device 710 to the inside of the device. The wired interface 720 may be composed of software drivers and hardware.

The wired interface 720 may include a controller corresponding to each input device, a device driver controlling the operation of the controller, and a kernel I/O subsystem that integrally manages input/output control requests of the device driver. The kernel I/O subsystem stores input/output requests from device drivers in a queue and schedules the requests based on request priority or device status.

The wired interface 720 may include interfaces such as PS/2, USB (Universal Serial Bus), Ethernet port, HDMI, MIPI CSI, DisplayPort, Thunderbolt, and the like.

The wired interface 720 may transmit input data, inference results of on-device AI, and the like to internal components or external objects of the device.

The communication device 730 refers to a configuration that receives and transmits certain information through an external wired or wireless network. The communication device 730 may be composed of a circuit including an antenna and a communication module (S/W module, chip, etc.) corresponding to a communication protocol. The communication protocol may be at least one of wired LAN (Ethernet), wireless LAN (IEEE 802.11), mobile communication (LTE, 5G NR, etc.), Bluetooth, NFC, and the like.

The communication device 730 may receive input data.

The communication device 730 may receive a constructed on-device AI. At this time, the on-device AI is a model trained through the process of FIGS. 2 to 3.

The communication device 730 may transmit inference results of on-device AI to external objects.

The processor 740 controls the operation of all components of the hardware device 700.

The processor 740 may perform operations on at least one application or computer program for executing methods/operations according to various embodiments of the present disclosure.

The processor 740 is a general-purpose processor that executes at least part of a control program installed in the storage device 760 or at least part of a program loaded in the memory 750.

The processor 740 may be implemented with circuitry (e.g., processing circuitry) such as a system on chip (SoC) or integrated circuit (IC).

The processor 740 may include one or more processors. For example, the processor 740 may include a combination of one or more processors such as a central processing unit (CPU), microprocessor unit (MPU), micro controller unit (MCU), graphic processing unit (GPU), neural processing unit (NPU), digital signal processor (DSP), application processor (AP), communication processor (CP), or any form of processor well known in the technical field of the present disclosure.

The memory 750 may store data generated during the inference process using on-device AI. The memory 750 is volatile memory such as DRAM or SRAM.

The storage device 760 may store unique information. The unique information may be device-specific information or personal unique information.

The storage device 760 may store on-device AI, hash functions, pseudo-random number generators, neuron activation matrices, inference results, and the like.

The on-device AI is composed of neurons trained according to the unique information of the hardware device 700. The on-device AI is a model trained with a positive dataset for neurons selected by the neuron activation matrix. Furthermore, the on-device AI may also be a model additionally trained with a negative dataset for neurons selected by the neuron deactivation matrix. This process is as described in FIGS. 2 and 3.

The hash function and pseudo-random number generator are the same as those used in the corresponding on-device AI construction process.

The storage device 760 may be implemented as a device such as a hard disk drive, solid state drive (SSD), USB flash drive, memory card, optical disk, or network-based storage device (Network Attached Storage, cloud storage, etc.).

The display device 770 may output an interface screen for inference, inference results, and the like.

The display device 770 may be implemented in various forms of devices.

The display device 770 may be implemented in various display methods such as liquid crystal, plasma, light-emitting diode, organic light-emitting diode, surface conduction electron-emitter, carbon nano-tube, nano-crystal, and the like.

The processor 740 extracts unique information of the hardware device 700. The processor 740 may read the unique information from the storage device 760 or secure area.

The processor 740 generates a neuron activation matrix based on the extracted unique information. The processor 740 may input the unique information into a hash function to generate a seed value. The processor 740 may initialize a pseudo-random number generator (PRNG) using the generated seed value. The processor 740 may deterministically generate neuron activation levels for each layer of the AI model using the initialized pseudo-random number generator.

The processor 740 may set neurons to be activated in the on-device AI model according to the neuron activation matrix. The processor 740 may select activated neurons by element-wise multiplication of the neurons of the on-device AI model and the neuron activation matrix. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The processor 740 may uniformly preprocess input data. Preprocessing may include noise removal, normalization, image cropping, tokenization, and the like.

The processor 740 may obtain an inference result using the on-device AI selectively activated according to the neuron activation matrix. The processor 740 may obtain an inference result by inputting input data or preprocessed input data to the selectively activated on-device AI.

The processor 740 may also dynamically adjust the activation level at the time of performing inference. The processor 740 may generate certain noise using a timestamp or counter value at the inference time as an additional seed. The processor 740 may initialize a pseudo-random number generator (PRNG) using a seed based on unique information and an additional seed in the random number generator. The processor 740 may generate a modified neuron activation matrix using the initialized pseudo-random number generator. Alternatively, the processor 740 may initialize a pseudo-random number generator (PRNG) with a timestamp or counter value at the inference time to generate noise. The processor 740 may add noise to the neuron activation matrix. Through this, the processor 740 may generate a modified neuron activation matrix.

The processor 740 may select activated neurons by element-wise multiplication of the neurons of the on-device AI model and the modified neuron activation matrix. The processor 740 may obtain an inference result using the on-device AI selectively activated according to the modified neuron activation matrix. The processor 740 may obtain an inference result by inputting input data or preprocessed input data to the selectively activated on-device AI.

Alternatively, the processor 740 extracts personal unique information stored in the hardware device 700.

The processor 740 generates a neuron activation matrix based on the extracted personal unique information. The processor 740 may input the personal unique information into a hash function to generate a seed value. The processor 740 may initialize a pseudo-random number generator (PRNG) using the generated seed value. The processor 740 may deterministically generate neuron activation levels for each layer of the AI model using the initialized pseudo-random number generator.

The processor 740 may set neurons to be activated in the on-device AI model according to the neuron activation matrix. The processor 740 may select activated neurons by element-wise multiplication of the neurons of the on-device AI model and the neuron activation matrix. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The processor 740 may uniformly preprocess input data. Preprocessing may include noise removal, normalization, image cropping, tokenization, and the like.

The processor 740 may obtain an inference result using the on-device AI selectively activated according to the neuron activation matrix. The processor 740 may obtain an inference result by inputting input data or preprocessed input data to the selectively activated on-device AI.

The processor 740 may also dynamically adjust the activation level at the time of performing inference. The processor 740 may generate certain noise using a timestamp or counter value at the inference time as an additional seed. The processor 740 may initialize a pseudo-random number generator (PRNG) using a seed based on personal unique information and an additional seed in the random number generator. The processor 740 may generate a modified neuron activation matrix using the initialized pseudo-random number generator. Alternatively, the processor 740 may initialize a pseudo-random number generator (PRNG) with a timestamp or counter value at the inference time to generate noise. The processor 740 may add noise to the neuron activation matrix. Through this, the processor 740 may generate a modified neuron activation matrix.

The processor 740 may select activated neurons by element-wise multiplication of the neurons of the on-device AI model and the modified neuron activation matrix. The processor 740 may obtain an inference result using the on-device AI selectively activated according to the modified neuron activation matrix. The processor 740 may obtain an inference result by inputting input data or preprocessed input data to the selectively activated on-device AI.

Alternatively, the processor 740 extracts a license key stored in the hardware device 700.

The processor 740 generates a neuron activation matrix based on the extracted license key. The processor 740 may input the license key into a hash function to generate a seed value. The processor 740 may initialize a pseudo-random number generator (PRNG) using the generated seed value. The processor 740 may deterministically generate neuron activation levels for each layer of the AI model using the initialized pseudo-random number generator.

The processor 740 may set neurons to be activated in the on-device AI model according to the neuron activation matrix. The processor 740 may select activated neurons by element-wise multiplication of the neurons of the on-device AI model and the neuron activation matrix. For example, a neuron with an activation level of 1 maintains its original weight, and a neuron with an activation level of 0 is masked to 0 and deactivated. In the case of soft activation mode, a neuron has a weight value obtained by multiplying the original weight by the activation level value.

The processor 740 may uniformly preprocess input data. Preprocessing may include noise removal, normalization, image cropping, tokenization, and the like.

The processor 740 may obtain an inference result using the on-device AI selectively activated according to the neuron activation matrix. The processor 740 may obtain an inference result by inputting input data or preprocessed input data to the selectively activated on-device AI.

The processor 740 may also dynamically adjust the activation level at the time of performing inference. The processor 740 may generate certain noise using a timestamp or counter value at the inference time as an additional seed. The processor 740 may initialize a pseudo-random number generator (PRNG) using a seed based on license key and an additional seed in the random number generator. The processor 740 may generate a modified neuron activation matrix using the initialized pseudo-random number generator. Alternatively, the processor 740 may initialize a pseudo-random number generator (PRNG) with a timestamp or counter value at the inference time to generate noise. The processor 740 may add noise to the neuron activation matrix. Through this, the processor 740 may generate a modified neuron activation matrix.

The processor 740 may select activated neurons by element-wise multiplication of the neurons of the on-device AI model and the modified neuron activation matrix. The processor 740 may obtain an inference result using the on-device AI selectively activated according to the modified neuron activation matrix. The processor 740 may obtain an inference result by inputting input data or preprocessed input data to the selectively activated on-device AI.

The term "module" used in this document may include a unit implemented in hardware, software, or firmware, and may be used interchangeably with terms such as logic, logic block, component, or circuit. A module may be an integrally configured component or a minimum unit or part thereof that performs one or more functions. For example, according to one embodiment, a module may be implemented in the form of an application-specific integrated circuit (ASIC).

Methods according to embodiments described in the specification of the present disclosure may be implemented in the form of hardware, software, or a combination of hardware and software.

When implemented in software, a computer-readable storage medium storing one or more programs (software modules) may be provided. One or more programs stored in the computer-readable storage medium are configured for execution by one or more processors in an electronic device. The one or more programs include instructions that cause the electronic device to execute methods according to embodiments described in the specification of the present disclosure.

Additionally, the on-device AI construction method and task performance method using on-device AI as described above may be implemented as a program (or application) including executable algorithms that may be executed on a computer. The program may be stored and provided on a transitory or non-transitory computer readable medium.

The non-transitory computer readable medium refers to a medium that stores data semi-permanently (e.g., the storage device) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

1. A method for generating a device-specific artificial intelligence model, comprising:
obtaining, by a hardware device, unique information of a specific device;
generating, by the hardware device, a neuron activation matrix based on the unique information;
setting, by the hardware device, a degree of activation for neurons by applying the neuron activation matrix to neurons of a neural network model; and
performing, by the hardware device, fine-tuning on the neurons for which the degree of activation has been set using a positive dataset.

2. The method of claim 1, wherein the unique information is device-specific information of the specific device or personal unique information of a user.

3. The method of claim 1, wherein the hardware device inputs the unique information into a hash function to generate a seed value, and generates the neuron activation matrix using a pseudo-random number generator initialized with the seed value.

4. The method of claim 1, wherein the neuron activation matrix stores a value according to hard activation or soft activation for each of the neurons.

5. The method of claim 1, wherein the hardware device sets the degree of activation for the neurons by element-wise applying the neuron activation matrix to parameters associated with the neurons.

6. The method of claim 1, further comprising:
generating, by the hardware device, a neuron deactivation matrix based on the neuron activation matrix;
setting deactivated neurons among the neurons by element-wise applying, by the hardware device, the neuron deactivation matrix to parameters associated with the neurons; and
performing, by the hardware device, fine-tuning on the deactivated neurons using a negative dataset.

7. A method for inference using a device-specific artificial intelligence model, comprising:
extracting, by a device, unique information of the device;
generating, by the device, a neuron activation matrix based on the unique information;
setting, by the device, a degree of activation for neurons by applying the neuron activation matrix to neurons of an on-device neural network model of the device; and
performing, by the device, inference by inputting input data to the on-device neural network model including neurons for which the degree of activation has been set,
wherein the on-device neural network model is a model on which fine-tuning has been performed on the neurons for which the degree of activation has been set using a positive dataset during a training process.

8. The method of claim 7, wherein the unique information is any one of device-specific information of the device, personal unique information of a user, or a license key.

9. The method of claim 7, wherein the device inputs the unique information into a hash function to generate a seed value, and generates the neuron activation matrix using a pseudo-random number generator initialized with the seed value.

10. The method of claim 7, wherein the device sets the degree of activation for the neurons by element-wise applying the neuron activation matrix to parameters associated with the neurons.

11. The method of claim 7, further comprising:
generating, by the device, a modified neuron activation matrix by applying noise to the neuron activation matrix using a timestamp or counter value at an inference time as an additional seed,
wherein the device performs the inference using the on-device neural network model including neurons for which the degree of activation has been set with the modified neuron activation matrix.

12. An apparatus for performing inference using a device-specific artificial intelligence model, comprising:
an input device configured to receive input data;
a storage device configured to store unique information and an on-device neural network model; and
a processor configured to generate a neuron activation matrix based on the unique information, set a degree of activation for neurons by applying the neuron activation matrix to neurons of the on-device neural network model, and perform inference by inputting the input data to the on-device neural network model including neurons for which the degree of activation has been set,
wherein the on-device neural network model is a model on which fine-tuning has been performed on the neurons for which the degree of activation has been set using a positive dataset during a training process.

13. The apparatus of claim 12, wherein the unique information is any one of device-specific information of the device, personal unique information of a user, or a license key.

14. The apparatus of claim 12, wherein the processor inputs the unique information into a hash function to generate a seed value, and generates the neuron activation matrix using a pseudo-random number generator initialized with the seed value.

15. The apparatus of claim 12, wherein the processor sets the degree of activation for the neurons by element-wise applying the neuron activation matrix to parameters associated with the neurons.

16. The apparatus of claim 12, wherein the processor:
generates a modified neuron activation matrix by applying noise to the neuron activation matrix using a timestamp or counter value at an inference time as an additional seed, and
performs the inference using the on-device neural network model including neurons for which the degree of activation has been set with the modified neuron activation matrix.
